(19) United States
(12) Patent Application Publication
(10) Pub. No.: US 2017/0361717 A1
(43) Pub. Date: Dec. 21, 2017

(54) SOLAR ENERGY BASED MOBILE ELECTRIC VEHICLE FAST CHARGER SYSTEM

(71) Applicants: Yu Qin, Troy, MI (US); Shanshan Du, Troy, MI (US)

(72) Inventors: Yu Qin, Troy, MI (US); Shanshan Du, Troy, MI (US)

(21) Appl. No.: 15/615,647

(22) Filed: Jun. 6, 2017

Related U.S. Application Data
(60) Provisional application No. 62/350,982, filed on Jun. 16, 2016.

(51) Int. Cl. B60L 11/18; H01M 10/46; H02J 7/00; H02J 3/38

(52) U.S. Cl. CPC B60L 11/185; H02J 3/383; H01M 10/465; H02J 7/0027; B60L 2230/22; Y02T 10/7094

(57) ABSTRACT

A solar energy based mobile EV fast charger (SE-MEVFC) system comprising a mobile EV fast charger system installed in the service track for providing EV charging service and a stationary solar energy generation system located in the charging station as power source for recharging mobile on-board storage battery, offers EV charging servicers for EVs where they stranded on the road or in remote area. The SE-MEVFC system has following unique features: (1) since it has universal battery interface, it can charge any EV battery; (2) since its energy source comes from solar energy based EV charging station, it provides 100% pollution free EV charging service; (3) since it is high power battery charger system, EV battery can be fully charged in minutes rather than hours, unlike those of prior art that use gasoline based generators to generate AC power and relies on low power EV on-board charger (OBC) to charge EV battery, namely, for over 2 hours charging time getting about 10 miles driving range. Therefore, a solar energy based mobile EV fast charger (SE-MEVFC) system can ease drivers' anxiety for not being able to find charging station effectively, and at same times it makes EV operation completely pollution free and hence increases MPGe of EVs.

### CROSS-REFERENCE TO RELATED APPLICATIONS

This application claims the benefit of U.S. Provisional Application 62/350,982 and hereby incorporates the application by reference.

### TECHNICAL FIELD

The present invention relates to non-stationary high power EV fast charger operating with a storage battery system that is replenished by solar energy, capable of providing EV fast charging services to EVs where they are stranded, such as but not limited to solar energy based mobile Electric Vehicle (EV) fast charger system.

### BACKGROUND

At the starting of the 21st century, the awareness for electric and other alternative fuel vehicles has increased due to growing concern over the problems that associate with hydrocarbon-fueled vehicles harming to the environment caused by their emissions and the sustainability of the current hydrocarbon-based transportation infrastructure. However the shortcoming of electrical vehicles (EV) is the limitation of driving range on their fully charged batteries and charging time. The range is usually between 60 to 300 miles per charge and charging time is between 8 hours to 10 hours or more, resulting in that EVs can be stranded on the road if their batteries are depleted or there is no EV charging station nearby. Therefore, high power mobile EV fast charger system is much needed to ease those emergency situations.

The techniques disclosed in Pat. Application WO 2012178010 A1, U.S. Pat. No. 6,979,913 B2 and U.S. Pat. No. 7,057,303 B2 represent the prior art of mobile EV chargers. However these prior art systems use regular fossil fuel power generator as power source. They suffer two major drawbacks: (1) since they use gasoline powered generator to produce AC power, they emit CO₂ harming the environment and causing significant reduction of Mile Per Gallon Equivalent (MPGe) of EV, which severely cut the benefit of EV itself and even defeat the purpose of using EV; (2) they merely produce AC power and relie on EV on board charger (OBC) to charge EV battery which would take hours due to its small charger. Therefore, it is ideal to provide solar energy based high power mobile EV fast charger to eliminate pollution, increase the MPGe of EV and decrease charging time effectively.

The object of this invention is to provide a pollution free, high efficient and high power solar energy based mobile EV fast charger (SE-MEVFC) system that offers EV fast charging service in minutes rather than hours to EVs where they are stranded on the road or in remote area.

### SUMMARY

One non-limiting aspect of the present invention contemplates a high power solar energy based mobile EV fast charger (SE-MEVFC) comprising three sections: 1. A high power mobile EV fast charger with a multi-function power conversion system (MFPCS), an universal battery interface system, an on-board battery system, an alternator power interface, and an alternator power source all mounted on a service truck; 2. a stationary solar power system with a solar power source, an AC power source, a MFPCS, LCL filter plus an isolation transformer, and multiple DC inductors interfaced with on-board battery system in mobile EV fast charger; 3. numerous system operation modes: EV fast charger with on-board battery mode (Mode 1), EV battery charger with truck alternator mode (Mode 2), on-board battery charger with truck alternator mode (Mode 3), on-board battery charger with solar power generation mode (Mode 4), an interleaved multi-phase on-board battery charger mode (Mode 5), on-board battery charger with AC grid power mode (Mode 6).

One non-limiting aspect of the present invention contemplates a MFPCS to provide DC/DC, DC/AC, AC/DC power conversion hardware functions comprising a three phase IGBT module mounted on a liquid cooled heatsink, connected to a DC-link capacitor, and controlled by a IGBT gate drive circuit card, a DSP interface circuit card, a Texas Instrument (TI) DSP control Card; a DC current sensor, three primary current sensors.

One non-limiting aspect of the present invention contemplates TI DSP control card to provide power conversion and battery charger software functions comprising Mode 1 control library comprising isolated EV fast charger control algorithms, Mode 2 control library comprising isolated EV fast charger control and DC/DC boost converter control algorithms, Mode 3 control library comprising DC/DC boost EV fast charger control algorithms, Mode 4 control library comprising three phase grid-tied inverter control plus direct on-board battery charger control algorithms, Mode 5 control library comprising interleaved multi-phase battery charger control algorithms, Mode 6 control library comprising PWM rectifier battery charger control algorithms.

One non-limiting aspect of the present invention contemplates high frequency (HF) isolated EV fast charger control algorithms to charge EV battery with on-board battery system comprising EV battery data base of voltage, current, temperature, state of charge (SOC), age, chemistry, charging requirements for all EV battery system, battery voltage and current control means, DC current control means, full bridge PWM means.

One non-limiting aspect of the present invention contemplates DC/DC boost converter control algorithms to regulate the DC-link voltage of mobile EV battery charger with truck alternator power comprising a DC voltage control means, a boost current control means, a boost PWM means.

One non-limiting aspect of the present invention contemplates DC/DC boost EV fast charger control algorithms to charge on-board battery with truck alternator power comprising battery voltage and current control means, a boost current control means, a boost PWM means.

One non-limiting aspect of the present invention contemplates three phase grid-tied inverter control plus direct on-board battery charger control algorithms to produce AC grid power and charge on-board battery with solar power directly at station when solar power is greater than battery voltage (V_{MP}>V_{B}) comprising maximum power point tracking (MPPT) means, DC voltage control means, battery charging power calculation means, AC current reference generation means, AC current control means, and Space Vector Modulation (SVM) means.

One non-limiting aspect of the present invention contemplates interleaved multiphase battery charger control algorithms to charge on-board battery with solar energy at station when solar power is less than battery voltage (V_{MP}<V_{B}) comprising an optimal solar energy tracking means, an battery voltage control means, a multiphase DC current control means, and interleaved multi-phase PWM means.

One non-limiting aspect of the present invention contemplates PWM rectifier battery charger control algorithms to convert AC grid power to DC charging on-board battery at station comprising battery voltage and current control means, AC current generation means, AC current control means and SVM means.

One non-limiting aspect of the present invention contemplates a mobile EV fast charger with on-board battery mode (Mode 1) comprising a configuration of HF isolated EV battery charger (when MFPCS connecting to on-board battery and universal battery interface which connecting to EV battery) and Mode 1 control library.

One non-limiting aspect of the present invention contemplates a mobile EV battery charger with truck alternator mode (Mode 2) comprising a configuration of a single phase boost converter (when one phase leg of MFPCS connecting to alternator power through a boost inductor), a HF isolated EV fast battery charger (when the other two phase legs of MFPCS connecting to universal battery interface which further connecting to EV battery) and Mode 2 control library.

One non-limiting aspect of the present invention contemplates an on-board battery charger with truck alternator mode (Mode 3) comprising a single phase boost battery charger configuration (when one phase leg of MFPCS connecting to alternator power through a boost inductor and to on-board battery) and Mode 3 control library.

One non-limiting aspect of the present invention contemplates an on-board battery charger with solar power generation mode (Mode 4) comprising a three phase grid tied inverter and direct on-board battery charger configuration (when solar power voltage is greater than battery voltage (V_{MP}>V_{B}) and with MFPCS connecting to stationary solar panels and on-board battery and to stationary LCL filter and isolation transformer which further connecting to AC grid power) and Mode 4 control library.

One non-limiting aspect of the present invention contemplates an interleaved multi-phase battery charger mode (Mode 5) comprising a three phase interleaved battery charger configuration (when solar power voltage is less than battery voltage (V_{MP}<V_{B}) and with MFPCS connecting to solar energy source through intermedium of multiple DC inductors and to on-board battery) and Mode 5 control library.

One non-limiting aspect of the present invention contemplates an on-board battery charger with AC grid power mode (Mode 6) comprising a PWM rectifier battery charger configuration (when MFPCS connecting to on-board battery and to LCL filter plus an isolation transformer which connecting to AC grid power source) and Mode 6 control library.

One non-limiting aspect of the present invention contemplates a universal battery interface system operable to charge any type of EV batteries comprising re-configurable high frequency (HF) transformer means, transformer re-configuration switch means, diode rectifier means, and output L-C filter means.

One non-limiting aspect of the present invention contemplates re-configuration HF transformers to provide galvanic isolation and universal battery voltage arrangement comprising one primary winding and two secondary windings with a turns ratio of n; primary winding connected in parallel while secondary windings placed in combination of series and/or parallel connections resulting in rescaling turns ratio to matching any EV voltage range.

One non-limiting aspect of the present invention contemplates transformer re-configuration switch means comprising transformer re-configuration control table which determines the relationship between effective transformer turns ratio and EV battery voltage ranges.

One non-limiting aspect of the present invention contemplates a mobile EV fast charger comprising an user interface allowing user to select EV model from EV battery data base or a communication interface allowing direct communication between mobile EV fast charger and EV when EV is in charging service, so as to setting right hardware configuration and launching corresponding battery charger control algorithms before battery charging process begins.

One non-limiting aspect of the present invention contemplates a solar energy based mobile EV fast charger (SE-MEVFC) system capable of charging EV battery in minutes and quickly re-loading solar energy to its on-board storage battery through a stationary solar energy system and its unique system configuration comprising: SE-MEVFC operating as EV fast charger with on-board battery in mode 1; SE-MEVFC operating as EV battery charger with truck alternator in mode 2; SE-MEVFC operating as on-board battery charger with truck alternator in mode 3; SE-MEVFC operating as on-board battery charger with solar power generation in mode 4; SE-MEVFC operating as interleaved multi-phase battery charger in mode 5; and SE-MEVFC operating as on-board battery charger with AC grid power in mode 6.

### BRIEF DESCRIPTION OF THE DRAWINGS

The present invention is pointed out with particularity in the appended claims. However, other features of the present invention will become more apparent and the present invention will be best understood by referencing to the following detailed description in conjunction with the accompany drawings in which:

FIG. 1 illustrates the functional block diagram of a solar energy based high power mobile EV fast charger system as contemplated by one non-limiting aspect of the present invention.

FIG. 2 schematically illustrates a MFPCS as contemplated by one non-limiting aspect of the present invention.

FIG. 3 schematically illustrates a universal battery interface system as contemplated by one non-limiting aspect of the present invention.

FIG. 4 illustrates a transformer re-configuration switches control table as contemplated by one non-limiting aspect of the present invention.

FIG. 5 schematically illustrates a mobile EV fast charger system having a MFPCS, a mobile on-board battery system, an universal battery interface system, a truck alternator power source and an alternator power interface, as contemplated by one non-limiting aspect of the present invention.

FIG. 6 schematically illustrates a mobile EV fast charger system operated as an on-board battery charger either by solar energy or AC grid power as contemplated by one non-limiting aspect of the present invention.

FIG. 7a illustrates the functional block diagram of universal EV fast charger control algorithms with a user interface function as contemplated by one non-limiting aspect of the present invention.

FIG. 7b illustrates the functional block diagram of universal EV fast charger control algorithms with a direct communication function as contemplated by one non-limiting aspect of the present invention.

FIG. 8 illustrates the functional block diagram of PWM rectifier battery charger control algorithms for recharging mobile on-board battery system as contemplated by one non-limiting aspect of the present invention.

FIG. 9 illustrates the functional block diagram of a DC/DC boost converter control as contemplated by one non-limiting aspect of the present invention.

FIG. 10 illustrates the functional block diagram of a DC/DC boost converter battery charger control algorithms as contemplated by one non-limiting aspect of the present invention.

FIG. 11 illustrates the functional block diagram of three phase grid tied inverter plus on-board battery charger control algorithms as contemplated by one non-limiting aspect of the present invention.

FIG. 12 illustrates the interleaved multi-phase on-board battery charger control algorithms as contemplated by one non-limiting aspect of the present invention.

### DETAILED DESCRIPTION

As required, detailed embodiments of the present invention are disclosed herein; However, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

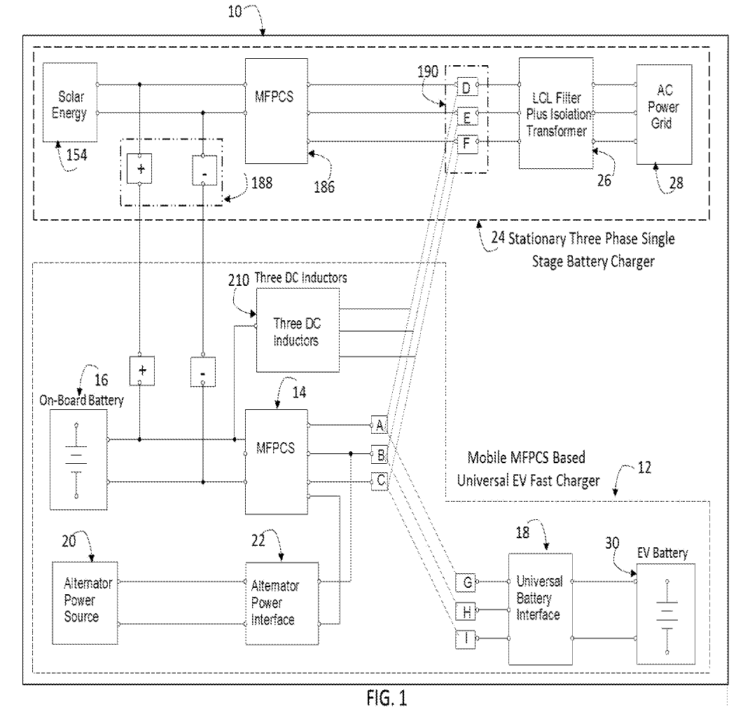

FIG. 1 illustrates a solar energy based high power mobile EV fast charger system 10 comprising a mobile EV fast charger 12 and a stationary solar power system 24. The mobile EV fast charger 12 comprising a MFPCS 14, a mobile on-board battery system 16, a universal battery interface system 18, a truck alternator power source 20, an alternator power interface system 22, three DC inductors, may charge a EV battery system 30 on the road using on-board batteries 16 or truck alternator power source 20, or charge on-board battery 16. The stationary solar power system 24 comprising a MFPCS 186, LCL filters plus isolation transformer 26, an AC power grid 28, solar energy 154, and mobile on-board battery recharging interfaces 188, 190, may re-charge the on-board battery 16 with either solar energy 154 or AC grid power 28 if needed or otherwise convert solar energy to AC grid power for supplying building loads. The mobile on-board batteries 16 may also be recharged by truck alternator power 20 when truck is moving.

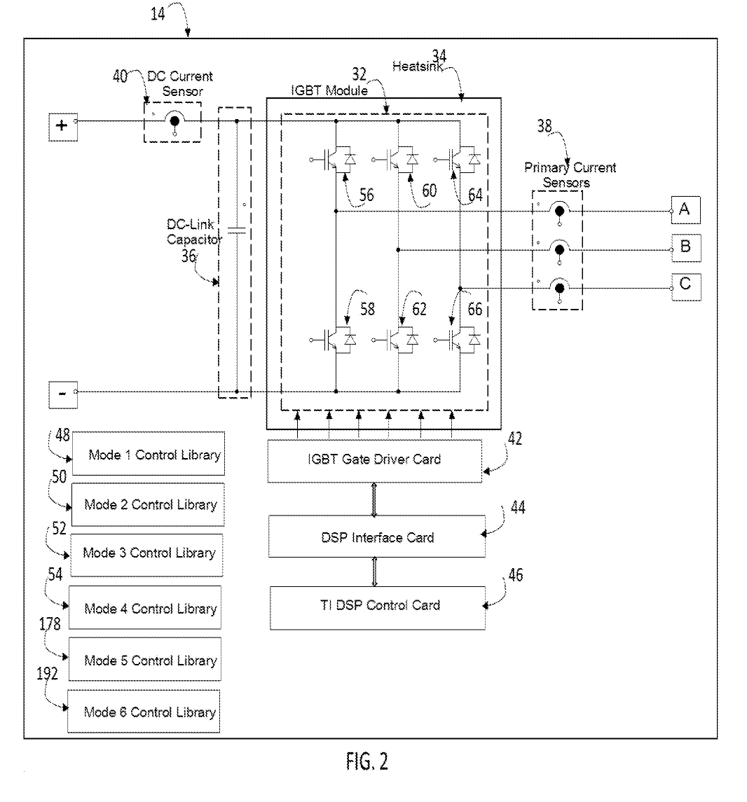

FIG. 2 schematically illustrates a MFPCS 14 having a IGBT module 32 mounted on a liquid cooled heatsink 34 and connected to a DC capacitor 36 as contemplated by one non-limiting aspect of the present invention. The MFPCS 14 is shown for exemplary and non-limiting purpose being as a power converter to facilitate DC/DC or AC/DC power converting functions utilized in either a EV fast charger with on-board battery mode (Mode 1), or a EV battery charger with truck alternator mode (Mode 2), or an on-board battery charger with truck alternator mode (Mode 3), or an on-board battery charger with solar power generation mode (Mode 4), or a interleaved multi-phase on-board battery charger with solar power mode (Mode 5), or an on-board battery charger with AC grid power mode (Mode 6).

A primary current sensing system 38 and a DC current sensing 40 may be included to facilitate sensing currents provided to primary winding of HF transformer in universal EV fast charger 12 or to LCL filter plus isolation transformer 26 in a three-phase single stage battery charger 24 and to DC input. The DSP interface card 44 may condition and filter feedback from current sensor 38, 40 and other sensing devices within the system, and provide the feedback signals to TI control card 46 for further processes. The TI control card 46 with Mode 1 control library 48, Mode 2 control library 50, Mode 3 control library 52, Mode 4 control library 54, Mode 5 control library 178, and Mode 6 control library 192 may cooperate with DSP interface card 44 and IGBT gate drive 42 to control IGBT module 32 such that the opening and closing switches 56, 58, 60, 62, 64, 66 can be coordinated to produce the desired voltage/current waveform patterns for DC/DC, DC/AC and AC/DC power conversions.

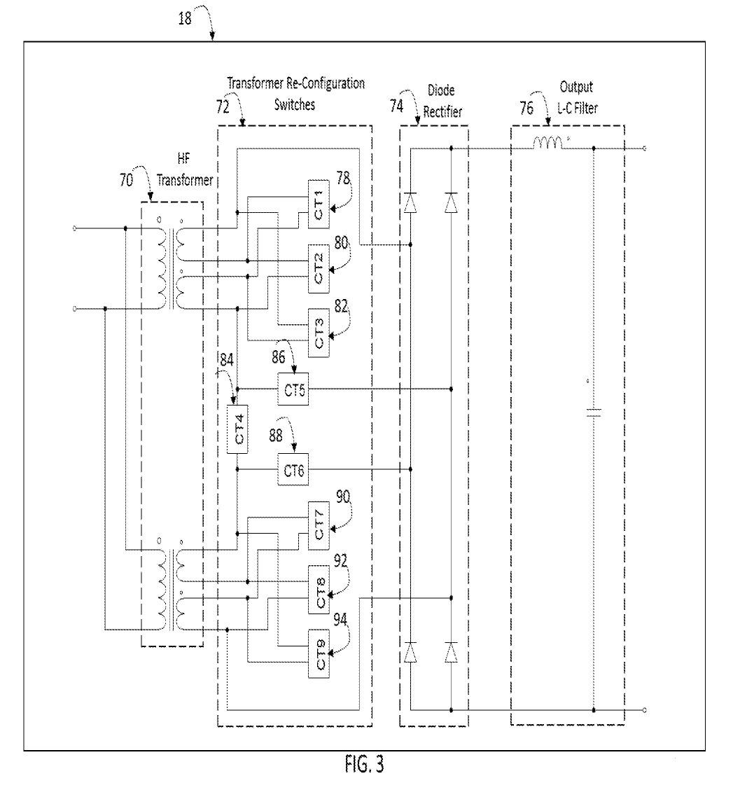

Universal battery interface system 18 illustrated in FIG. 3 comprising two identical HF transformers 70 with each transformer having one primary winding and two separated secondary windings, a set of On-Off transformer reconfiguration switches 72 connecting those secondary windings to output circuits, a diode rectifier circuit 74 converting an AC voltage pulse trains to DC ones, a output L-C filter 76 eliminating HF switching harmonic components, may be reconfigured automatically such that it interfaces with EV batteries with any voltage range.

The output voltage amplitude of a MFPCS based universal EV fast charger 12 (In FIG. 1) is determined by transformer turns ratio n, the connection of primary windings, the connection of secondary windings, and the PWM control of the power converter. Two HF transformers with turns ratio n are configured in such way that primary windings are connected in parallel while the secondary windings are operated in combination of series and/or parallel connections with the opening and closing of switches 78, 80, 82, 84, 86, 88, 90, 92, 94 under DSP control to achieve a voltage level matching that of EV battery system 30 (In FIG. 1).

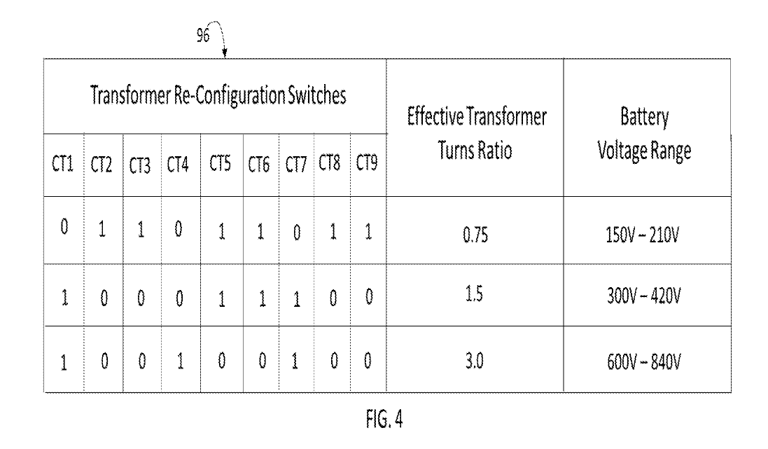

FIG. 4 illustrates a transformer re-configuration control table 96 used by a controller to match the EV fast charger voltage range with any EV batteries when on-board battery voltage range is 300v-420v and transformer turns ratio is 1.5. For example, when CT1=0, CT2=1, CT3=1, CT4=0, CT5=1, CT6=1, CT7=0, CT8=1, CT9=1, the mobile EV fast charger operates in battery voltage range of 150v-210v; when CT1=1, CT2=0, CT3=0, CT4=0, CT5=1, CT6=1, CT7=1, CT8=0, CT9=0, the mobile EV fast charger operates in battery voltage range of 300v-420v; when CT1=1, CT2=0, CT3=0, CT4=1, CT5=0, CT6=0, CT7=1, CT8=0, CT9=0, the mobile EV super charger operates in battery voltage range of 600v-840v.

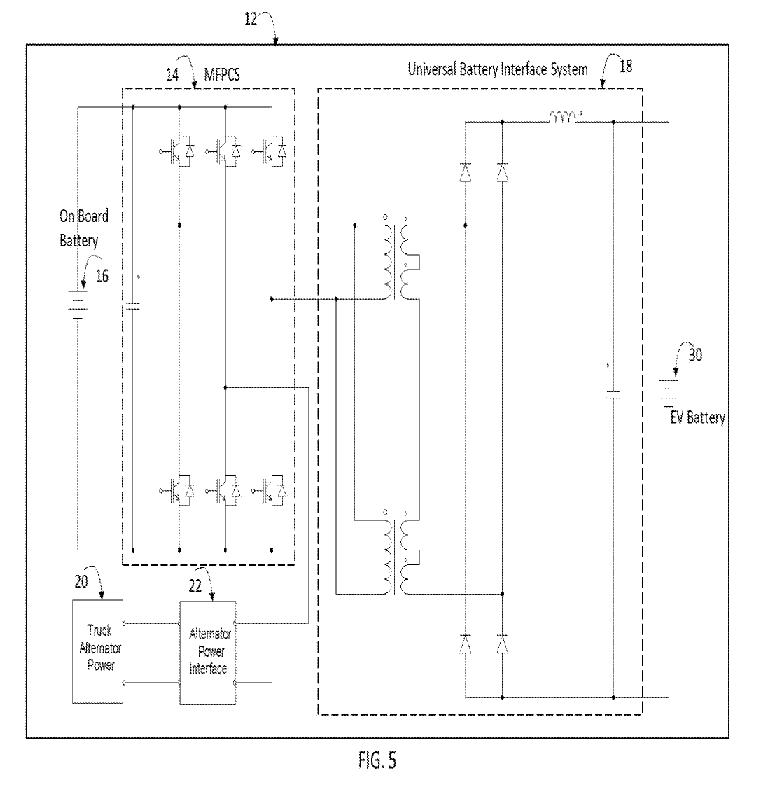

FIG. 5 schematically illustrates an exemplary mobile EV fast charger 12 operated in either Mode 1 or Mode 2 configurations to charge EV battery system 30 having a 600-800V voltage range, or Mode 3 configuration to charge mobile on-board battery 16 with truck alternator power. In Mode 1 operation MFPCS 14 with its DC-link capacitor connected to mobile on-board battery system 16, and with two phase legs connected to universal battery interface system 18 with transformer re-configurable switches operated as CT1=1, CT2=0, CT3=0, CT4=1, CT5=0, CT6=0, CT7=1, CT8=0, CT9=0, is operated as a HF transformer isolated Full-Bridge (FB) DC/DC converter to charge EV battery system 30 with on-board battery system 16. In Mode 2 operation MFPCS 14 with one phase leg connected to a alternator network comprising truck alternator power 20 and alternator power interface 22, and with two other phase legs connected to universal battery interface system 18, is operated as a HF transformer isolated Full-Bridge (FB) DC/DC converter to charge EV battery system 30 with truck alternator power 20 if on-board battery 16 is depleted. In Mode 3 operation MFPCS 14 with its DC-link capacitor connected to mobile on-board battery system 16, and with one phase leg connected to a alternator network comprising truck alternator power 20 and alternator power interface 22, is operated as a single phase boost battery charger to charge on-board battery system 16 when truck is moving.

FIG. 6 schematically illustrates an mobile EV fast charger 10 operated in either Mode 4 or Mode 5 or Mode 6 configurations to re-charge mobile on-board battery system 16 at charging station. In Mode 4 operation where solar power voltage is greater than battery voltage (V_{MP}>V_{B}) MFPCS 14 with its DC-link capacitor connected to mobile on-board battery 16 and stationary solar energy 154, and with three phase legs connected to stationary LCL filters plus isolation transformer 26 which connecting to AC power grid 28, is operated as three phase grid tied inverter and direct on-board battery charger to produce AC grid power 28 and charge on-board battery 16 with solar energy 154 directly. In Mode 5 operation where solar power voltage is less than battery voltage (V_{MP}<V_{B}) MFPCS connected to solar energy 154 through multiple DC inductors 210 and to on-board battery 16, is operated as three-phase interleaved battery charger to charge on-board battery 16 using solar energy 154. In Mode 6 operation where solar energy 154 is not present MFPCS 14 is operated as a PWM rectifier battery charger to charge on-board battery 16 with AC grid power 28.

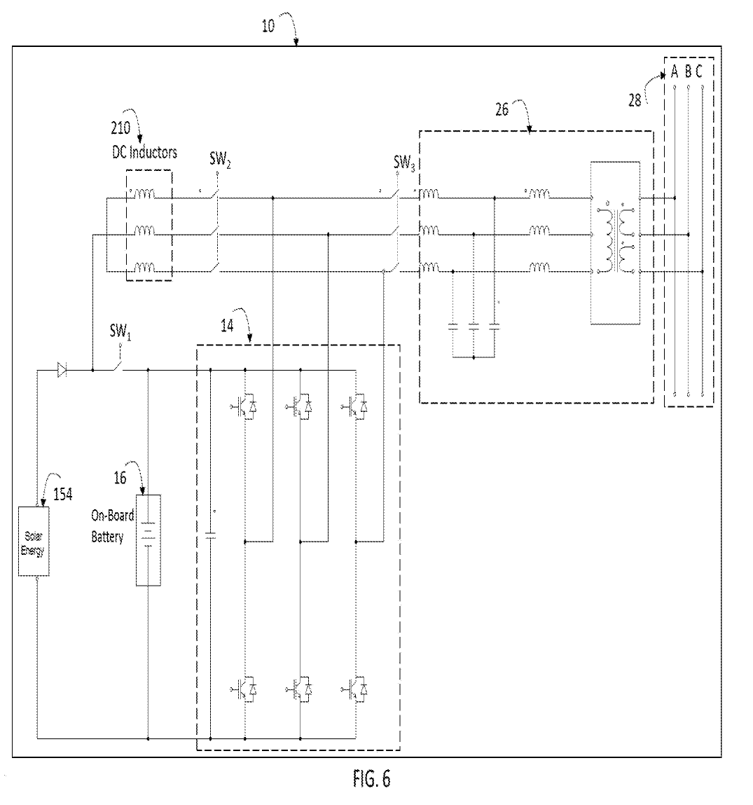

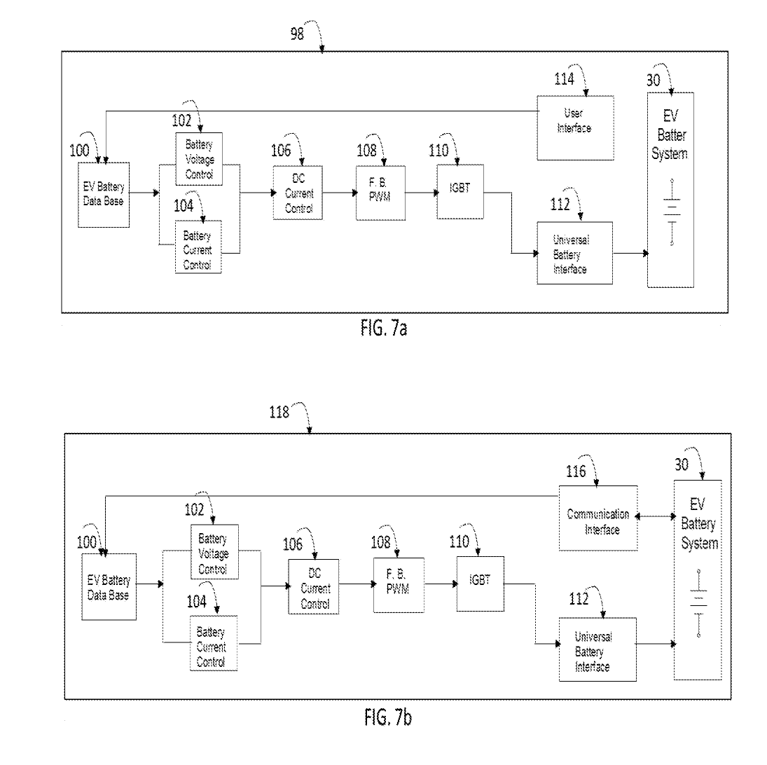

FIGS. 7a, 7b illustrate universal EV fast charger with user interface control algorithms 98 and universal EV fast charger with communication interface control algorithms 118. In both control algorithms 98 and 118, they incorporate a EV battery data base 100 providing battery voltage reference and battery current reference to battery voltage control 102 and battery current control 104 based on the battery information including but not limited to EV manufacturer and model number, chemistry, voltage and current ranges, Stage of Charge (SOC), temperatures and charging requirements. While the battery voltage is regulated by battery voltage control 102 in constant voltage mode, the battery current is regulated by battery current control 104 in constant current mode. Using the output of either voltage control 102 or current control 104, a DC current control 106 regulates DC current by commanding full-bridge PWM 108 to generate PWM signals controlling IGBT 110 to produce AC voltage pulse trains for universal battery interface 112 which provides optimal charging voltage and current for an EV battery system 30.

In control algorithms 98, an user interface 114 may be included allowing the operator of a mobile EV super charger to select the EV model from EV battery data base 100 so that the corresponding hardware configuration and battery charging control algorithms are selected before the battery charging process begin. In control algorithms 118, a communication interface 116 which establishes an instant communication between a mobile EV fast charger and a EV when they are connected, may automatically reconfigured the hardware and select battery charging control algorithms before the battery charging process begin.

In the functional block diagram of PWM rectifier charger control algorithms 120 as illustrated in FIG. 8, While the battery voltage is regulated by battery voltage control 102 in constant voltage mode, the battery current is regulated by battery current control 104 in constant current mode. Using the output of either voltage control 102 or current control 104, an AC current reference generation 126 produces current references for AC current control 128 which regulates AC current by commanding SVM 130 to generate PWM signals controlling IGBT 132 to charge mobile on-board batteries 16 with AC grid power.

In the functional block diagram of DC/DC boost converter control algorithms 134 as illustrated in FIG. 9, the DC voltage control 136 regulates the DC voltage by generating a reference for DC current control 106. The current control 106 regulates DC current by commanding boost PWM 140 to generate PWM signals controlling IGBT 142 to boost lower voltage of truck alternator to 420V at DC Link Capacitor 36 inside MFPCS 14 (in FIG. 2). This 420V voltage at DC Link Capacitor 36 is used by HF transformer isolated Full-Bridge (FB) DC/DC converter to charge EV battery system 30 (in FIG. 5).

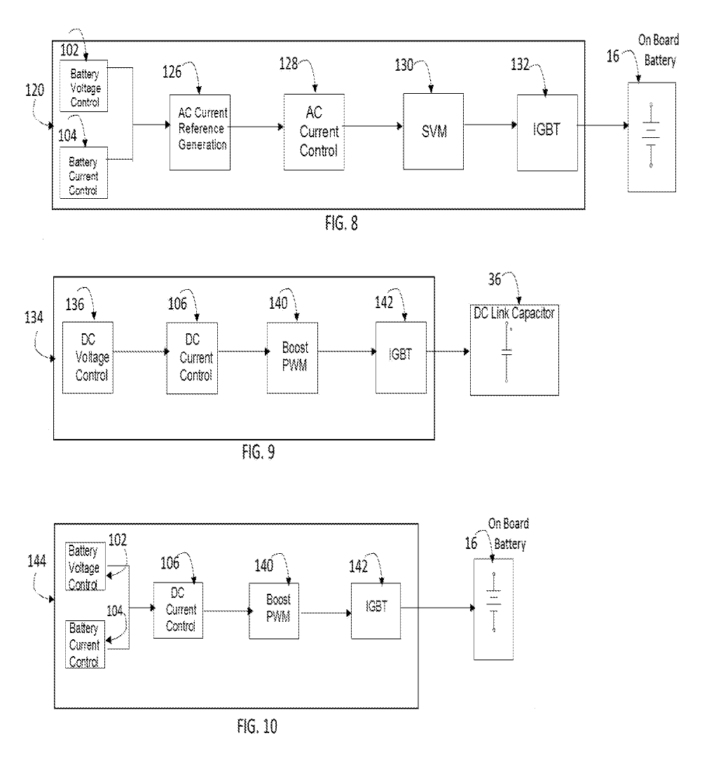

In the functional block diagram of DC/DC boost battery charger control algorithms 144 as illustrated in FIG. 10, while the battery voltage is regulated by battery voltage control 102 in constant voltage mode, the battery current is regulated by battery current control 104 in constant current mode. Using the output of either voltage control 102 or current control 104 as DC current reference, the DC current control 106 regulates DC current by commanding boost PWM 140 to generate PWM signals controlling IGBT 142 to recharge mobile on-board batteries 16 with truck alternator power.

In the functional block diagram of three phase grid-tied inverter plus direct on-board battery charger control algorithms 156 as illustrated in FIG. 11, Maximum Power Point Tracking (MPPT) 160 extract the maximum solar power by producing dynamic voltage reference to DC voltage control 148. DC voltage control 148 regulates DC voltage by generating solar power command 164. It is then subtracted from required on-board battery charging power 166 calculated by block 158 based on on-board battery charging current reference I_{BR} 184 and EV battery voltage V_{B} 182 to get inverter power command 168. Inverter power command 168 is fed to AC current reference generation 126 to create current reference for AC current control 128 which regulates AC current by commanding SVM 130 to generate PWM signals controlling IGBT 176 to provide on-board battery charging power with part of solar energy 154 (FIG. 6) and convert the rest to AC grid power.

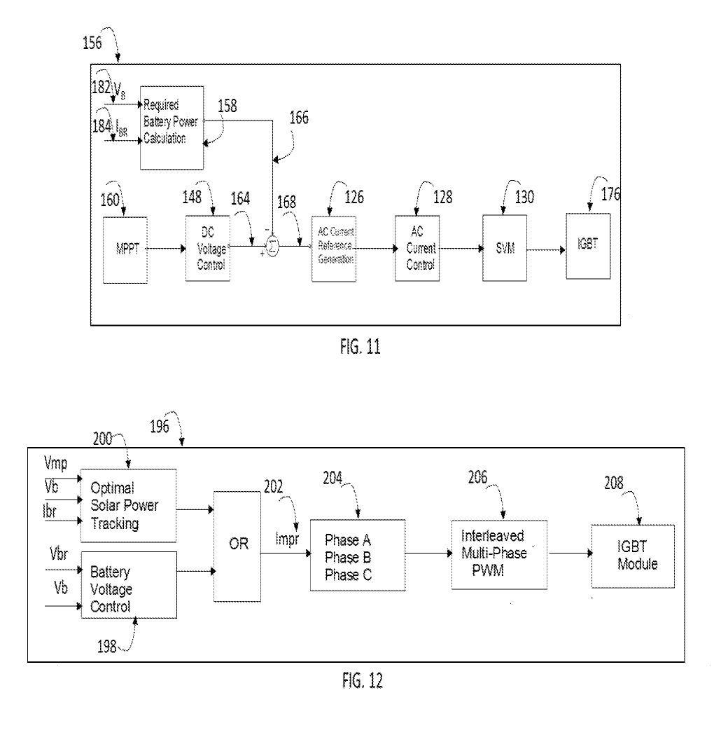

FIG. 12 illustrates the functional block diagram 196 of interleaved multi-phase on-board battery charger control algorithms. In diagram 196 where battery voltage is regulated by battery voltage control 198, battery current is regulated by optimal solar power tracking 200. The output I_{MPR} 202 of either 198 or 200 is fed into multi-phase current control 204 to regulate DC current of each DC inductor by commanding interleaved multi-phase PWM 206 to generate signals controlling IGBT 208 to charge on-board battery 16 (in FIG. 6).

While exemplary embodiments are described above, it is not intended that these embodiments describe all possible forms of the invention, rather, the words used in the specification are words of description rather than limitation, and it is understood that various changes may be made without depart from the sprit and scope of the invention. Additionally, the features of various implementing embodiments may be combined to form further embodiments of the invention.

What is claimed is:

1. A high power mobile EV fast charger system uses solar energy based storage battery system to charge EV battery in minutes, said system comprising:
a mobile EV fast charger with a multi-function power conversion system (MFPCS), an universal battery interface system, an on-board battery system, three DC inductors, an alternator power interface, and an alternator power source all mounted on a service truck;
a stationary solar power system with a solar power source, an AC power source, a MFPCS, LCL filter plus an isolation transformer, and interfaces with on-board battery system in mobile EV fast charger;
numerous system operation modes: EV fast charger with on-board battery mode (Mode 1), EV battery charger with truck alternator mode (Mode 2), on-board battery charger with truck alternator mode (Mode 3), on-board battery charger with solar power generation mode (Mode 4), an interleaved multi-phase on-board battery charger mode (Mode 5), on-board battery charger with AC grid power mode (Mode 6).

2. The said MFPCS of claim 1 further comprising a three phase IGBT module on a liquid cooled heatsink; connected to a DC-link capacitor, DC current sensor, primary current sensors; and controlled by a IGBT gate drive circuit card, a DSP interface circuit card, a Texas Instrument (TI) DSP control Card; provides DC/DC power conversion and EV battery charger hardware functions.

3. The said TI DSP control Card of claim 2 further comprising Mode 1 control library comprising high frequency (HF) isolated EV fast charger control algorithms, Mode 2 control library comprising isolated EV fast charger control and DC/DC boost converter control algorithms, Mode 3 control library comprising DC/DC boost EV fast charger control algorithms, Mode 4 control library comprising three phase grid-tied inverter control plus direct on-board battery charger control algorithms, Mode 5 control library comprising interleaved multi-phase on-board battery charger control algorithms, Mode 6 control library comprising PWM rectifier battery charger control algorithms, provides power conversion and battery charger software functions.

4. The said high frequency (HF) isolated EV fast charger control algorithms of claim 3 further comprises EV battery data base of voltage, current, temperature, state of charge (SOC), age, chemistry, charging requirement, and battery voltage and current means, DC current control means, full bridge PWM means, to charge EV battery with on-board battery system.

5. The said DC/DC boost converter control algorithms of claim 3 further comprises a DC voltage control means, a boost current control means, a boost PWM means to regulate DC-link voltage of the said EV battery charger with alternator power.

6. The said DC/DC boost EV fast charger control algorithms of claim 3 further comprises battery voltage and current control means, a boost current control means, a boost PWM means to charge on-board battery with alternator power.

7. The said three phase grid-tied inverter control plus direct on-board battery charger control algorithms of claim 3 further comprises maximum power point tracking (MPPT) means, DC voltage control means, battery charging power calculation means, AC current reference generation means, AC current control means, SVM means to produce AC grid power and charge on-board battery with solar power directly.

8. The said interleaved multi-phase battery charger control algorithms of claim 3 further comprises an optimal solar energy tracking means to regulate charging current of said on-board battery in constant current mode, a battery control means to regulate charging voltage of said on-board battery in constant voltage mode, a multi-phase DC current control means to regulate DC current of said DC inductors, an interleaved multi-phase PWM means to generate control signals for said three phase IGBT module.

9. The said PWM rectifier battery charger control algorithms of claim 3 further comprises battery voltage and current control means, AC current generation means, AC current control means and space vector modulation (SVM) means to convert AC grid power to DC charging the said on-board battery.

10. The said EV fast charger with on-board battery mode (Mode 1) of claim 1 further comprises a configuration of HF isolated EV battery charger (when said MFPCS connecting to said on-board battery and said universal battery interface which connecting to said EV battery) and Mode 1 control library.

11. The said EV battery charger with truck alternator mode (Mode 2) of claim 1 further comprises a configuration of single phase boost converter (when one phase leg of said MFPCS connecting to alternator power through a boost inductor), a HF isolated EV fast battery charger (when the other two phase legs of said MFPCS connecting to said universal battery interface which connecting to said EV battery) and Mode 2 control library.

12. The said on-board battery charger with truck alternator mode (Mode 3) of claim 1 further comprises a single phase boost battery charger configuration (when one phase leg of said MFPCS connecting to alternator power through a boost inductor and to on-board battery) and Mode 3 control library.

13. The said on-board battery charger with solar power generation mode (Mode 4) of claim 1 further comprises a three phase grid tied inverter and direct on-board battery charger configuration (when solar power voltage is greater than battery voltage (V_{MP}>V_{B}) and with MFPCS connecting to stationary solar panels and to stationary LCL filter and isolation transformer which connecting to AC grid power) and Mode 4 control library.

14. The said interleaved multi-phase on-board charger mode (Mode 5) of claim 1 further comprises a three phase interleaved battery charger configuration (when solar power voltage is less than battery voltage (V_{MP}<V_{B}) and with MFPCS connecting to solar energy source through intermedium of multiple DC inductors) and Mode 5 control library.

15. The said on-board battery charger with AC grid power mode (Mode 6) of claim 1 further comprises PWM rectifier battery charger configuration (when said MFPCS connecting to said on-board battery and said LCL filter and isolation transformer which connecting to said AC grid power source) and Mode 6 control library.

16. The said universal battery interface system of claim 1 further comprising a high frequency (HF) transformer means, transformer re-configuration switch means, diode rectifier means, output L-C filter means, is operable to charge any type of EV batteries.

17. The said re-configuration HF transformer of claim 16 further comprising one primary winding and two secondary windings with a turns ratio of n, primary winding connected to in parallel while secondary windings placed in combination of series and/or parallel resulting in rescaling turns ratio to matching EV voltage range, provides galvanic isolation and universal battery voltage arrangement.

18. The said transformer re-configuration switch means of claim 16 further comprises transformer re-configuration control table which determines the relationship between effective transformer turns ratio and EV battery voltage ranges.

19. The said mobile EV fast charger of claim 1 further comprises an user interface allowing user to select EV model from EV battery data base, or a communication interface allowing direct communication between mobile EV fast charger and EV battery when EV is in charging service, so as to setting right hardware configuration and launching corresponding battery charger control algorithms before battery charging process begins.

20. A solar energy based mobile EV fast charger system (SE-MEVFC) capable of charging EV battery in minutes and quickly re-loading solar energy to its on-board storage battery through a stationary solar energy system and its unique system configuration comprising: SE-MEVFC operating as EV fast charger with on-board battery in Mode 1; SE-MEVFC operating as EV battery charger with truck alternator in Mode 2; SE-MEVFC operating as on-board battery charger with truck alternator in Mode 3; SE-MEVFC operating as on-board battery charger with solar power generation in Mode 4; SE-MEVFC operating as an interleaved on-board battery charger in Mode 5, SE-MEVFC operating as on-board battery charger with AC grid power in Mode 6.
